(19) United States
(12) Patent Application Publication
(10) Pub. No.: US 2010/0148050 A1
(43) Pub. Date: Jun. 17, 2010

(54) SECURITY MARK

(76) Inventor: Mazhar Ali Bari, Dublin (IE)

Correspondence Address: HAYNES AND BOONE, LLP;IP Section, 2323 Victory Avenue, Suite 700, Dallas, TX, 75219, US

(21) Appl. No.: 12/530,608

(22) PCT Filed: Mar. 10, 2008
(86) PCT No.: PCT/GB2008/000820

§ 371 Date: Feb. 18, 2010

(30) Foreign Application Priority Data
Mar. 9, 2007 (GB) 0704642.8

(51) Int. Cl. G06K 7/10; G06K 9/00

(52) U.S. Cl. 250/271; 382/100

(57) ABSTRACT

A security mark (130) that comprises a metamaterial such that properties of the metamaterial provides authentication of the security mark (130). The metamaterial may have a negative refractive index. An article may be secured by applying the metamaterial to the article such that properties of the metamaterial authenticate the article. The metamaterial may be arranged to form an image (160) when illuminated by terahertz radiation.

### FIELD OF THE INVENTION

The present invention relates to a security mark and in particular a security mark attached to an article.

### BACKGROUND OF THE INVENTION

Counterfeiting goods is a significant threat to many industries. Counterfeit banknotes and legal documents cause particular problems but more recently such a threat has affected industries such as software, music and video entertainment, pharmaceutical products, clothing, jewelry and other high value goods. As counterfeiters get more sophisticated, industry has to implement more and more secure ways to protect their products and consumers who buy these products.

Current anti-counterfeiting techniques include the addition of holograms, watermarks and special printing inks and these are particularly applied to banknotes, for example. However, such techniques require individual inspection of each item for verification. For instance, a stack of banknotes may contain individual counterfeit notes and so each note must be checked individually to ensure that all are genuine.

Furthermore, existing security marks become easier to replicate as technology advances and becomes more readily available.

Therefore, there is required a security mark that overcomes these problems.

### SUMMARY OF THE INVENTION

In accordance with a first aspect of the present invention there is provided a security mark that comprises a metamaterial such that properties of the metamaterial provides authentication of the security mark. Metamaterials are generally not found in nature and interact with radiation in a different way to that of other materials. Therefore, these differences may be used to determine whether the mark is genuine or not. The response to incident radiation may be detected using refractive, diffractive or other dispersive techniques.

Preferably, the metamaterial is sensitive to radiation in the infrared or terahertz range. This allows the radiation to pass through the bulk of the material of the product or item to be protected and interact in a detectable way with the security mark. In particular, paper, cloth and plastic have a low attenuation co-efficient for terahertz radiation and may be suitable materials to be protected by such a security mark.

Preferably, the metamaterial is also a negative refractive index material (NIM). NIMs provides a different response to incident radiation of a particular wavelength compared with conventional materials and so further enhances the security of the mark.

In order to determine if a security mark is genuine or not, the mark may be illuminated with a particular wavelength or range of wavelengths and the response to this radiation may be detected. The response of genuine marks may then differ from the response of fakes.

Advantageously, the metamaterial may be formed as a pattern to generate an image which may convey additional information.

The metamaterial may be incorporated into the fabric of the item, (for instance, a banknote) or placed directly onto the item or applied to a tag.

The security mark may be fabricated using optical or imprint lithography or screen printed.

According to a second aspect of the present invention there is provided apparatus for reading a security mark comprising an infrared (IR) or terahertz radiation source arranged to illuminate the security mark and a detector arranged to detect a radiation interacting with the security mark. A security mark or article attached to the security mark may be placed between a radiation source and a detector or arranged such that the radiation reflects off the security mark and detected by a detector. The detector measures the response of the security mark (or fake) and authenticates the security mark depending on its response to the incident radiation. Marks that exhibit a convention (non-metamaterial) response may indicate a fake, whereas marks that respond in a way expected from a metamaterial indicate the genuine article.

Preferably, the metamaterial is also a NIM and so properties of the security mark relating to refraction may be used to determine authenticity. These properties include the way that the security mark (or fake) alters the incident radiation. These properties may include angular deflection and polarization effects.

Many materials are transparent or substantially transparent to infrared or terahertz radiation. Therefore, when articles to be secured are made from such substantially transparent materials several articles may be stacked together and investigated or authenticated simultaneously. Furthermore, the marks may be covered so they are not visible under visible wavelengths, i.e. invisible to the naked eye, but the apparatus may nevertheless determine whether the marks are genuine or not. Removal of the cover, for instance paint or dye, may disrupt the security mark in such a way to indicate tampering. Tampering may also be determined using the response of the tag to IR or terahertz radiation.

According to a third aspect of the present invention there is provided a method of securing an article comprising applying a metamaterial to the article such that properties of the metamaterial authenticate the article. The metamaterial may also be a part of the article itself.

Preferably, the metamaterial is a negative index material.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of an apparatus for reading a security mark according to a first embodiment of the present invention, given by way of example only;

FIG. 2 shows an enlarged view of the security mark of FIG. 1;

FIG. 3 shows a schematic diagram of an apparatus for reading a security mark according to a second embodiment of the present invention, given by way of example only;

FIG. 4 shows a schematic diagram of a security tag according to a third embodiment of the present invention, given by way of example only;

FIG. 5 shows a schematic diagram of a three layer unit cell of an array forming a left-handed material;

FIG. 6 shows a schematic diagram of a further three layer unit cell of an array forming a left-handed material;

FIG. 7 shows a schematic diagram of a further three layer unit cell of an array forming a left-handed material;

FIG. 8 shows a schematic diagram of an array formed from a plurality of the three layer unit cells of FIG. 5;

FIG. 9 shows a graph showing a THz response of the three layer array of FIG. 8 and a THz response of a single layer array; and

FIG. 10 shows a graph showing a THz response of the three layer array of FIG. 9 for both horizontal and vertical polarization radiation.

It should be noted that the figures are illustrated for simplicity and are not necessarily drawn to scale.

### DETAILED DESCRIPTION OF THE PREFERRED EMBODIMENTS

Terahertz radiation lies on the boundary of millimetre waves and the infrared (IR) and runs between 3 mm to 15 μm. Terahertz radiation may penetrate non-polar substances such as paper, cloth and plastic with little attenuation. Non-polar liquids are substantially transparent as well, whereas polar liquids such as water are highly absorptive. Metals completely block or reflect terahertz radiation.

The refractive index in optics gives the factor by which the phase velocity of light is decreased against the flow of energy. In materials with a negative refractive index the phase velocity is directed against the flow of energy. Although there are no known naturally occurring negative-index materials (NIMs), artificially designed materials (metamaterials) can act as NIMs. Materials that can be characterised by a dielectric permittivity ε=ε′+iε″ and a magnetic permeability μ=μ′+iμ″ and have a negative real part of the complex refractive index if the following conditions are satisfied, in a particular frequency interval:

ε′<0 and μ′<0 (V. G. Veselago, Sov. Phys. Usp. 10, 509, (1968)).

These materials exhibit an electromagnetic response not readily available in naturally occurring materials such as negative refractive index.

Furthermore, NIM patterns can be defined that allow for coupling with the magnetic component of an electromagnetic field without the presence of any magnetic material. This is especially important in the terahertz region where no natural magnetic resonance exists.

By way of example, the invention may be put into practice in the following way.

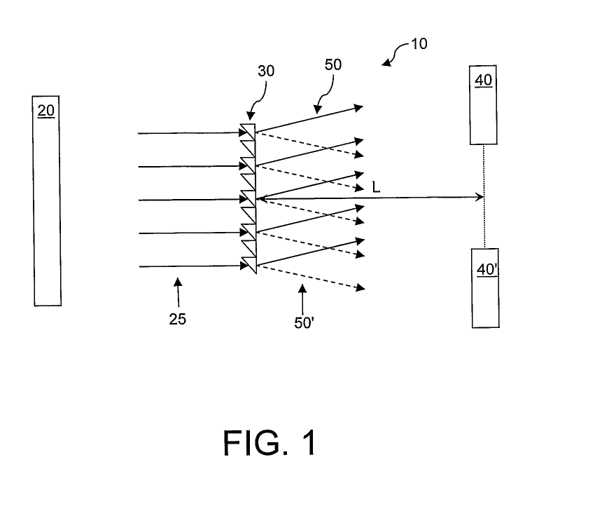

FIG. 1 shows a schematic diagram of an apparatus 10 for measuring the electromagnetic response of security mark 30 to be authenticated. A source of terahertz or IR radiation 20 may be capable of producing a parallel or a converging beam 25. The beam may interact with a security mark 30 which comprises a metamaterial that has a negative refractive index for the wavelength provided by the source 20. In this example, the NIM is arranged as a series of prisms in the security mark 30 that each refract a portion of the incoming beam 25.

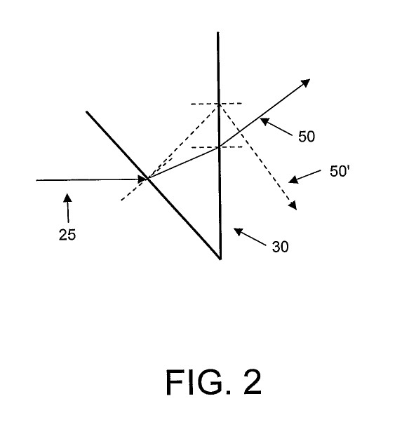

FIG. 2 shows an enlarged view of one such prism within the security mark 30. The solid line 50 indicates how the beam is refracted conventionally, i.e. if the material was not a metamaterial for this particular wavelength. The dash line 50′ shows how the beam may be refracted when the material is a metamaterial for the particular wavelength of beam 25.

Two detectors 40, 40′ are arranged to detect at least portions of the refracted light. When the security mark 30 is not made from a metamaterial, i.e. is a fake, the refracted light may be directed conventionally onto detector 40, located at a different position to detector 40′. However, when a genuine metamaterial security tag 30 is present beam 25 will be refracted by a different angle forming beam 50′ which may be detected by detector 40′. In this way, genuine security marks may be authenticated.

In an alternative embodiment, instead of two separate detectors, a single detector may be used. In this alternative, the single detector may be scanned between the two detector positions shown in FIG. 1 or remain static at the position of detector 40′, in which case a lack of signal at this detector site indicates a fake.

In FIG. 1 prisms have been shown as the dispersive elements although other refracting elements may be substituted.

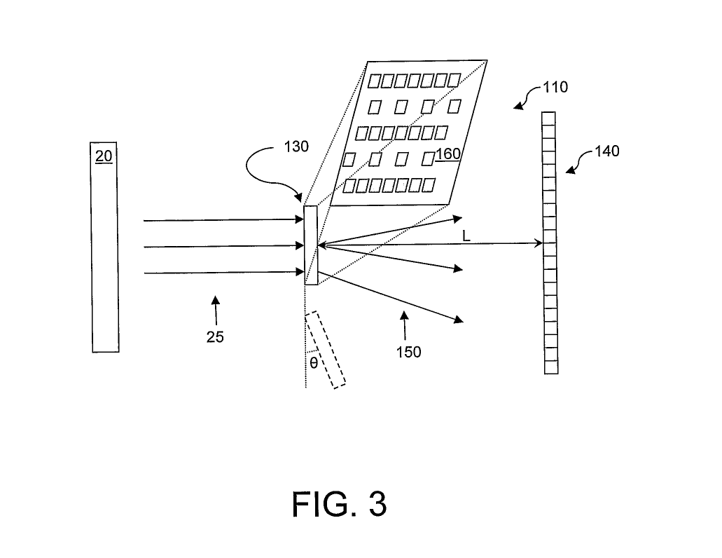

FIG. 3 shows an alternative embodiment. Similar features have the same reference numerals as described with reference to FIG. 1. This second embodiment is based upon a diffraction technique rather than refraction as in FIG. 1. Security mark 130 diffracts the beam 25, which may be infrared or terahertz radiation. The diffracted beam 150 may be detected by an array detector 140 (or similarly a scanning detector). The array detector 140 may be a two-dimensional array, such as a CCD, and the diffraction pattern 160 is shown as a two-dimensional diffraction pattern.

In the embodiment of FIG. 3 authentication may be determined by properties of the particular diffraction pattern or image detected. A non-metamaterial or non-NIM may produce a different or unregistered diffraction pattern indicating a fake. The diffraction image may be additionally used to convey data regarding the security mark. Such information may be encoded within the diffraction image 160.

The dotted outline of security mark 130 shown in FIG. 3 indicates that the security mark 130 may be aligned to the incident beam 25 at different angles to the normal orientation shown in the solid line. The angle of incidence may be altered with respect to one, two or three mutually orthogonal axis to the incident radiation 25. This variation in angle may be used to enlarge the diffraction pattern along particular directions as imaged by the detection elements in the array detector 140. Increasing the angle allows lower spatial resolution detection arrays to be used (or with a shortened dispersive path length L). The information encoded in the tag may be specific to particular angles of incidence. In other words, the information conveyed by the diffraction images may alter depending on the orientation of the security or angle of incidence. Therefore, a security mark rotator may be used to position the mark.

The security marks may be fabricated using optical or imprint lithography or screen printing techniques. Such techniques may be suitable to provide the micrometer or nanometre feature sizes necessary to fabricate a metamaterial, which may also have the property of being a negative refractive index material for IR or terahertz radiation. For the diffraction image forming security mark in particular, structured multilayer absorptive, phase-shifting or reflective diffraction gratings may be fabricated, relying respectively on the spatial variations of the imaginary, real parts of the refractive index or in reflection coefficient.

The materials used to fabricate the security marks may include metal-insulator composites, micro and nano-resonator structured materials, materials consisting of combinations of conducting and insulating polymers like polyaniline (PANI) and PTFE, for instance. The structuring may be produced by micro or nano-imprint lithography, UV lithography, E-beam lithography, for instance. The apparatus shown in FIG. 1 provides a one bit (true/false) information store. However, varying the prismatic structures in either one, two or three dimensions may provide much higher data density with a potential for kilobits of data per cm². Increasing the data density requires an increase in the number of detectors and the speed required to read the security mark. The detector elements themselves may be CCD arrays, photodiodes, phototransistors, ultra-high frequency detectors, or bolometers, for instance.

Similar materials may be used to fabricate the diffraction based security mark shown in FIG. 3. However, the information density available with the diffraction based technique may be much higher and potentially mega-bits per cm² due to the increase in detail available from a diffraction image. Similar detectors may also be used as to those described with reference to FIG. 1.

As an alternative security mark to those shown in FIG. 1 or 3, the security mark may comprise of several metamaterial layers as shown in FIG. 4. Whereas for the single contrast layer structures shown in FIGS. 1 and 3 a quasi-monochromatic radiation source (or a true monochromatic source) is suitable, multi-layer structures, as shown in FIG. 4, maybe constructed that exhibit wavelengths selectivity. Therefore, multi-layer structures or metamaterials including NIMs, may be read using polychromatic sources or multiple monochromatic sources with one source or band corresponding to each layer. Referring to FIG. 4, layer 210 may be a top layer or cover, layer 220 may be a Mylar layer, layer 230 may be a metal layer, and layer 240 may be the bottom layer or substrate, for instance. It should be noted that various different numbers of layers and combinations may be used. For instance, the substrate 240 and/or the top layer 210 may not be present leaving two or three layers rather than four layers as shows in FIG. 4. Furthermore, an additional layer or layers may be present in alternative security marks. With a multi-layer security mark a broad wavelength range may be used. Should an article affixed to the security mark absorb strongly radiation in one band another wavelength or band may penetrate the article sufficiently to obtain a response from at least one of the other bands. Alternatively, a higher authenticity may be demanded in which case all or more than one layer must provide an authentic response to prove that the security mark is genuine.

In “Left-handed metamaterials: The fishnet structure and its variations”, M. Kafesaki et al, Phys. Rev. B 75, 235114 (2007) various structures having theoretical metamaterial properties in the microwave (GHz) region are described. These materials are in the form of “fishnets” made from an array of unit cells. Each unit cell is formed from two conductive layers separated by a dielectric layer.

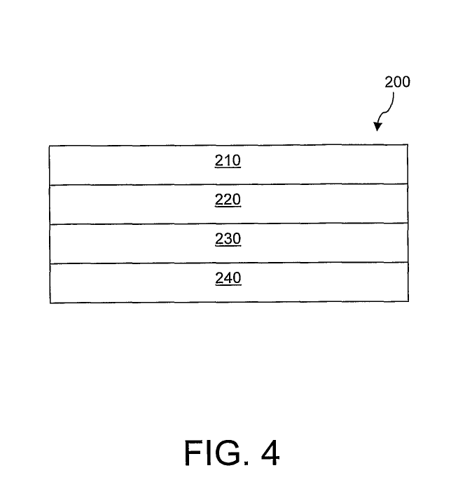

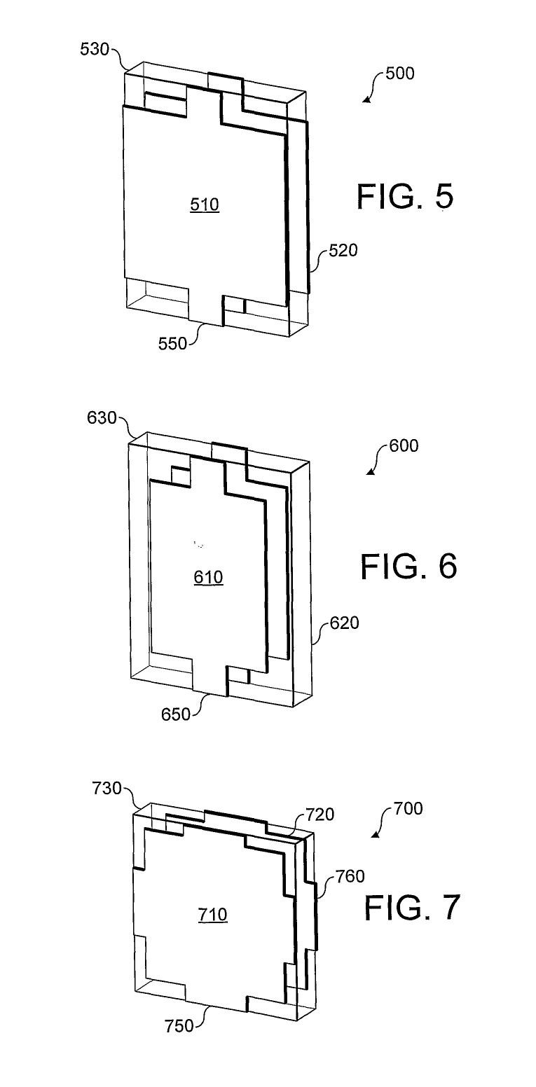

The shape of three such unit cells are shown in FIGS. 5, 6 and 7. These three figures show unit cells 500, 600 and 700 having conductive layers 510, 610, 710 and 530, 630, 730 separated by dielectric layers 520, 620 and 720, respectively.

FIG. 5 shows a substantially square cell 500 having necks or wires 550 extending from distal sides of the cell 500. The cells may be connected in a longitudinal direction by these necks or wires 550. The necks or wires 550 provide a continuous connection that provides a plasmonic electric response. The cells 500 may be connected in a transverse direction by abutting the edges of the cells 500 to form a contiguous periodic repetition of the unit cell. This form does not significantly affect the frequency of the electromagnetic response.

FIG. 6 shows a substantially rectangular cell 600 again with wires or necks 650 arranged to connect the cells longitudinally.

FIG. 7 shows a substantially quadrate cross shaped cell 700 (a square or rectangle superimposed on a cross) with the tips of the cross forming wires or necks 750, 760 to form connections between each cell in both the longitudinal and transverse directions.

The aforementioned paper describes the unit cells as having dimensions of 2-3 mm with necks of 1.5 mm and a 1.6 mm thick dielectric layer 530, 630, 730. Furthermore, the author suggests an array of 18×13×3 unit cells, i.e. a relatively small number of cells. The structure of such an array will therefore be clearly visible to the unaided eye and is therefore not particularly suitable for use as a security mark as its structure may be relatively easy to discern without sophisticated equipment or expertise and reproduction may also be relatively simple to achieve.

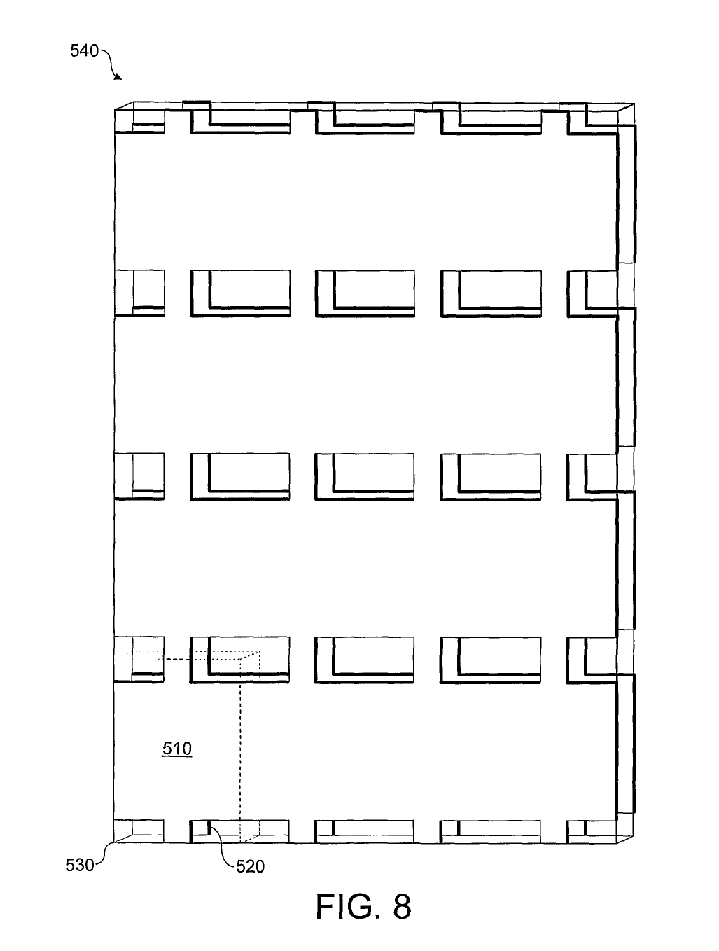

FIG. 8 shows an array 540 or fishnet of cells having the shape of cells 500, connected together. However, whereas the size of the cells described in the aforementioned paper allows visible inspection and quite easy reproduction the size of each individual cell 500 (one such cell 500 is highlighted by dotted lines) and the thickness of the dielectric layer 530 as used in an embodiment of the present invention are much smaller (for instance, of the order of 10-100 μm rather than 1-2 mm) than that proposed in the aforementioned paper. The dimensions of the cell 500 may be chosen such that visible inspection and reproduction are difficult or impossible without use of a microscope, for instance. This also allows the array to exhibit left-handed behaviour in the THz frequency range (rather than GHz range as described in the paper). Such a reduced size array is therefore more suitable for use as a security mark. The benefits of THz radiation have been described above.

The dielectric layer 530 may be a continuous slab or sheet and the conductive layers may be thin compared with the thickness of the dielectric layer, e.g. less than about 1 μm (compared with 1-2 mm in the aforementioned paper).

Furthermore, the smaller array size allows the use of imprint and lithographic manufacturing technology to produce large number unit cell arrays (>100s, 1000s, 10000s or more). This may be compared with the 18×13×3=702 described in the paper, which is a relatively low number.

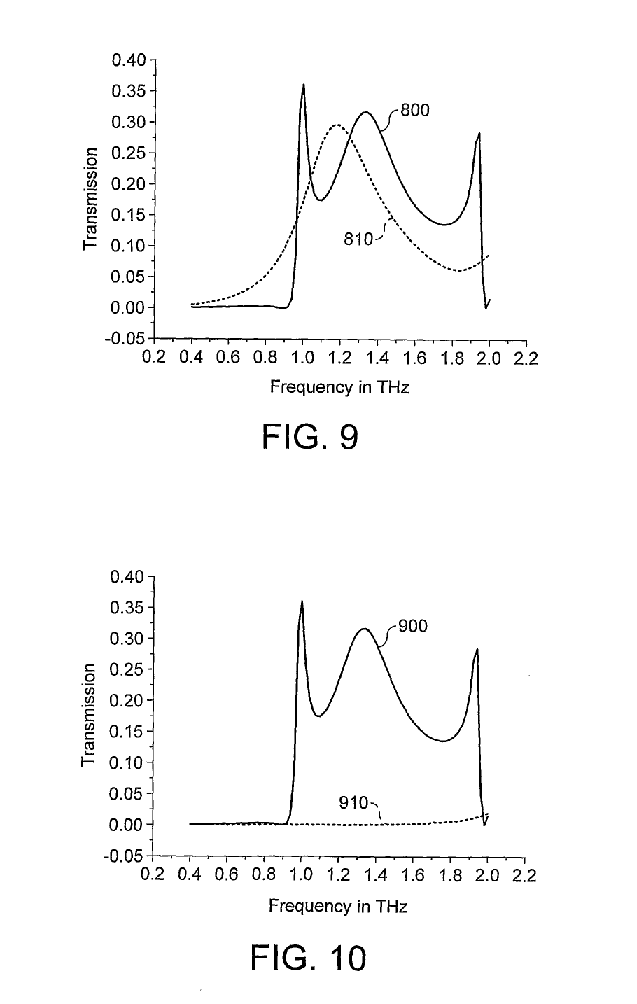

FIG. 9 shows an example THz response 800 from the three layer array 540 of FIG. 8 compared with the THz response 810 (shown as a dotted line) of a single layer array of cells of substantially the same shape (one of the conductive layers shown in FIG. 8 only) array. In this example the response 800 of the three-layer array 540 provides a sharp rise at around 1 THz. There is a marked difference at this point compared with the single layer response 810, which has a lower gradient at this point. Such a spectral feature may be used to distinguish between a three-layer array and a single-layer array when penetrated by radiation between about 0.1 THz and 10 THz. Therefore, a simplified detector at this frequency only (or to compare the relative magnitude at two frequencies or more specific frequencies) may be used.

A counterfeiter analysing the three-layer array may be able to reproduce the appearance of it (by for instance visual inspection) by replicating the top conductive layer only. However, as the dielectric layer may be quite thin (around 5-200 μm or preferably 5-50 μm or more preferably 5-30 μm and in the current example 21 μm) this dielectric layer and the second conductive layer 520 may not be discernable from a single-layer structure. Furthermore, the counterfeiter may not have access to a THz source or detection equipment. Therefore, such a three-layer (or more) structure may be used as a security mark and applied to a product.

The dielectric layer may be for instance, polypropylene or Mylar. The conductive layer may be a metal such as copper, aluminium, gold, silver, polyaniline (PANI) or other conductive polymers, for instance.

The transmission for THz radiation for the array 540 shown in FIG. 8 is polarization dependent. This is shown in FIG. 10, which is a graph of the THz radiation response 900 for vertically polarized incident radiation and the THz radiation response 910 (shown as a dotted line) for horizontally polarized incident radiation. Therefore, when using the array 540 as a security mark careful alignment may be necessary. This may not be convenient when checking large numbers of products, for instance, but may provide additional security protection.

However, an array formed from cells 700 having the shape shown in FIG. 7 will provide a polarization independent response and so may be more suitable for this use.

The cell 500, 600, 700 widths (transverse direction) may be around 50˜150 μm. The example of the array 540 in FIG. 8 has cell widths of 91 μm. The cell lengths (longitudinal direction) may be 100-200 μm. the example of array 540 in FIG. 8 has cell lengths of 123 μm. However, any dimensions that provides a suitable response (negative refractive index, metamaterial properties and/or left-handed behaviour) using terahertz radiation (0.1-10 THz or 0.1-15 THz, for instance) may be used.

Although repeating identical cells have been described non-identical cells maybe used. This may also provide a mark that incorporates encoded information.

The aforementioned security marks may be applied to many different items to ensure authenticity. These items may include pharmaceuticals, clothing and fashion items such as perfume, CDs or DVDs or banknotes and other high valued documents, for example.

In CDs and DVDs the security mark may be applied to the packaging or directly to the disk itself. The security mark may be applied to the disk in a region not designated to store data such as the central part around the central hole of the disk or may be applied across the face of the data region using a metamaterial that does not interfere with the reading wavelength for the disk.

In pharmaceuticals the security mark may be applied to the packaging, the blister packs containing tablets or directly to the drug or tablet itself. In this case, the metamaterial should be edible and harmless.

In banknotes, the security mark may be incorporated into the fabric of the banknote itself or within the metallic strip common to many banknote types. The security mark may contain the serial number of the banknote for added security, for instance.

When individual items are stacked together, in small numbers (for instance, of the order 10, such as 1-20 or 1-100), such as CDs in a shipping container or blisters of pills, the security marks for each item may be read simultaneously without needing to open the carton. In this way, individual fakes contained within cartons of genuine articles may be identified. Such an application may be useful at customs checks and ports, for instance.

As will be appreciated by the skilled person, details of the above embodiment may be varied without departing from the scope of the present invention, as defined by the appended claims.

For example, a holographic technique may be used to form an image from a metamaterial or more particularly a NIM security mark, similar to holography techniques used in the visible region of the electromagnetic spectrum. In this alternative embodiment the incident beam of radiation 25 may be split into two or more beams by means of reflective, polarising or other optical elements with sufficient efficiency in the infrared and terahertz regions. One of the beams may be allowed to diffract from the security mark and one or more of the remaining beams may be allowed to interfere to form a one, two or three dimensional hologram at the detector site. Again, the hologram may be used to store and transmit data or other information. Coherent sources of radiation may be used to form holograms in this way.

The security mark described may also be applied to legal documents (passports, driving licences, ID, etc) and paintings or other artworks.

The cell shapes shown in FIGS. 5, 6 and 7 are examples only with many other shapes possible.

Many combinations, modifications, or alterations to the features of the above embodiments will be readily apparent to the skilled person and are intended to form part of the invention.

1-60. (canceled)

61. A security mark comprising a metamaterial such that properties of the metamaterial provides authentication of the security mark.

62. The security mark of claim 61, wherein the metamaterial is a negative refractive index material.

63. The security mark according to claim 61, wherein the metamaterial is arranged to form an image when illuminated by terahertz radiation.

64. The security mark of claim 61, wherein the metamaterial is arranged to form a detectable and repeatable diffraction image in use.

65. The security mark of claim 64, wherein the metamaterial is arranged as a diffraction grating.

66. The security mark according to claim 64, wherein the image stores information.

67. The security mark according to claim 64, wherein the image is a holographic image.

68. The security mark according to claim 64, wherein in use the image varies with the angle of incident radiation.

69. The security mark according to claim 64, wherein in use a different image is formed depending on the orientation of the security mark.

70. The security mark according to claim 64, wherein in use a different image is formed with the security mark aligned along each of the three mutually orthogonal axes to the incident radiation.

71. The security mark according to claim 61, wherein the metamaterial is any combination of a conductor, an insulator and/or a semiconductor arranged to form a phase or amplitude contrast.

72. A security tag comprising the security mark according to claim 61.

73. The security tag of claim 72 further comprising a cover arranged such that the security mark is invisible to visible wavelength light.

74. An article having the security mark of claim 61.

75. The article of claim 74, wherein the article is a bank note or a document.

76. Apparatus for reading a security mark comprising:
an IR or Terahertz radiation source arranged to illuminate the security mark of claim 61; and
a detector arranged to detect radiation interacting with the security mark.

77. The apparatus of claim 76, wherein the detector is selected from the group consisting of: CCD, a photodiode, phototransistor, ultra-high frequency detector, bolometer and photomultiplier tube.

78. The apparatus according to claim 76 further comprising a beam splitter arranged to split a beam from the radiation source into a plurality of beams such that one of the plurality of beams interacts with the security mark before interfering with another of the plurality of beams to form a one, two or three dimensional holographic image at the detector.

79. A method of securing an article comprising applying a metamaterial to the article such that properties of the metamaterial authenticate the article.

80. Use of a metamaterial as a security mark for authenticating an article.
